(19) United States
(12) Patent Application Publication
(10) Pub. No.: US 2005/0053756 A1
(43) Pub. Date: Mar. 10, 2005

(54) High strength fiber/fabric/film based animal toy

(76) Inventor: Glen S. Axelrod, Colts Neck, NJ (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/656,464

(22) Filed: Sep. 5, 2003

(51) Int. Cl. B32B 1/04; B32B 3/00; B32B 3/02

(52) U.S. Cl. 428/71; 119/707; 428/74; 428/76

(57) ABSTRACT

A fabric, fiber or film based animal toy is provided having improved rupture and tear resistance. The animal toy includes a body including a compressible material and a fabric or film material disposed over at least a portion of the compressible material. The fabric material includes high strength fibers having a tensile strength greater than or equal to 50,000 psi and/or a modulus greater than or equal to 500,000 psi. The film material includes films having a tensile strength equal to or greater than 20,000 psi, and modulus value equal to or greater than 500,000 psi. In addition, the fibers and/or film employed herein is fiber and/or film material of relatively high monoaxial or biaxial polymer chain orientation.

### FIELD OF THE INVENTION

The present invention is directed at an animal toy, and more particularly at an animal toy comprising fiber/fabric/film material having improved puncture resistance and tear resistance. The animal chew includes a fabric material that includes fibers having mechanical properties associated with, e.g., high tensile strength and high modulus, and based upon the family of fiber materials made of polymers with high degrees of molecular orientation.

### BACKGROUND OF THE INVENTION

Many domestic pets, such as dogs and cats, enjoy playing with toys by chewing, scratching, pulling and pushing them, or moving them around with their nose, teeth, and front legs, or hind legs for cats. This behavior is natural to animals, keeps the animals active while assisting in the development of their motor coordination. Also, playing with such toys provides pets with an outlet for these natural instincts, helps prevent boredom, and is psychologically rewarding. When such toys are not available for the animal, the animal may exercise these natural tendencies on any available items. Uncontrolled “play” may therefore result in damage to items surrounding the pet. For example, domestic pets can damage furniture, carpeting, walls, and shoes.

In addition to providing exercise for a pet and an outlet for the animal's natural tendencies for chewing, scratching, etc., toys may often play an important role in the interaction between an owner and pet. For example, an owner and pet may engage in a game of fetch, tug-of-war, and the like. Interactive play of this type has been found useful for developing a positive relationship between an owner and pet.

Of course, the prior art is replete with various toys intended for animals. Some examples of the chew and play toys available for animals are rawhide chews or bones, cloth pulls and ropes, as well as various vinyl, plastic, rubber and latex toys. In such category of alternatives, fabric or stuffed animal toys are often one toy variety of choice for interactive play between an owner and pet. Fabric and stuffed toys are also soft and typically appealing to both the pet and consumer.

Unfortunately, fabric or stuffed animal toys often have a downside, amongst which is a relatively short life span. One reason is that chewing or scratching of such products tends to rupture the fabric and destroy any useful life. Similarly, tugging or pulling on the stuffed animal toy also tends to rip the fabric material into several pieces. In either circumstance, the stuffed toy rapidly deteriorates, loosing stuffing and even having portions ripped completely free from the toy. Indeed, these modes of failure are the common result of everyday play, not to mention the fact that especially vigorous play accelerates such destruction resulting in an even shorter toy life span.

In addition, while the prior art discloses, generally, certain types of puncture resistant fabric materials, a search of the U.S. Patent Abstract database under the term “puncture resistant” and “fabric” revealed the following, none of which were directed at animal chew toys: U.S. Pat. Nos. 4,923,105; 4,980,228; 4,997,688; 5,087,499; 5,100,724; 5,149,582; 5,996,255; 6,052,829; 6,094,748; 6,167,639; 6,280,547 and 6,368,989.

Accordingly, it is an object of the present invention to provide a fabric or stuffed animal toy that reduces tearing or damage when chewed or as a result of continued and/or vigorous play.

More specifically, it is an object of the present invention to employ high performance fiber/fabric materials, in woven form, for use in a animal toy, so that the consumer is provided with an otherwise “soft” chew toy that maintains a longer lifespan for the pet owner.

In such regard, it is a specific object of the present invention to selectively employ fiber materials made of highly oriented polymer resins, wherein the high monoaxial orientation of the polymer chains, e.g., orientation levels exceeding 50%, and typically greater than 75%, and preferably over 90%, impart excellent tensile strength, and modulus values, when applied in either a monolayer or multilayer type fabric configuration, for an animal chew toy application.

### SUMMARY OF THE INVENTION

According to one aspect, the present invention comprises an animal toy including a body portion, in which the body portion includes a compressible material and a first fiber, fabric or film type material disposed at least partially or fully over the compressible material. The first fiber or fabric material includes fibers having a tensile strength greater than or equal to 50,000 psi and/or a modulus greater than or equal to 500,000 psi. The fibers/fabric may also be selectively configured to improve upon the puncture resistance and overall mechanical strength, and be selectively position on the toy at those locations that are more prone to chewing, such as the perimeter or end portions, as the case may be. Alternatively, the fabric is composed of fiber material derived from polymer resins of high relative monoaxial orientation, wherein the monoaxial orientation is present at levels above at least 50%. In addition, as noted, the invention herein applies to film material with the corresponding mechanical properties or polymer orientation characteristics.

### DETAILED DESCRIPTION OF THE PREFERRED EMBODIMENTS

In accordance with the present invention an animal toy having improved durability and resistance to damage by the animal is disclosed. The animal toy of the present invention generally includes a body having at least a layer made of a fabric or film material that resists tearing and rupture. Accordingly, the animal toy has an enhanced resistance to biting, ripping, scratching, etc. Resistance to these effects is provided by including fibers or film having high tensile strength and high modulus, and an overall improved resistance to puncture.

As used herein, a fabric material contemplates woven, non-woven, and knitted materials, as well as other fiber based materials. The fabric material responsible for increasing the durability of the animal toy herein includes fiber components having a high tensile strength and/or high modulus. When such fibers are integrated into a fabric material, the fabric material may exhibit increased tear strength and/or tear resistance and/or puncture resistance. The fabric may also have increased rupture strength, and may also have improved abrasion resistance. Fabric material that includes fibers having high tensile strength and high modulus may generally be referred to as a high performance fabric. The benefits of the invention may be achieved using a fabric material made entirely of such high strength fibers. Alternatively, the fabric material may include high strength fibers blended or interwoven, etc., with conventional fiber material. Alternatively, the fabric material with the aforementioned characteristics can be selectively positioned on the chew at those locations that are more prone to the chewing or biting action of the animal.

The high strength fibers used in the fabric material are preferably high performance polymeric fibers. The fibers are characterized by high mechanical strength properties. Particularly, tensile strength and modulus are considered to be one of the hallmark properties for the invention herein. Fibers consistent with the present invention have a tensile strength that is at least 50,000 psi and above. Preferably, the tensile strength of the fibers is greater than at least 100,000 psi, and more preferably the fibers exhibit a tensile strength of 200,000 psi or greater. Of course all increments from 50,000 psi and up are contemplated herein.

The fibers included in the fabric materials herein also may have a modulus of 500,000 psi or greater. Preferably, the modulus values of 1 Mpsi (1,000,000 psi) and above are demonstrated by the fibers. Most preferably, the fibers herein will have a modulus that is at least in the range of 1 Mpsi to 30 Mpsi. All incremental modulus values of 500,000 psi and above are contemplated herein.

Alternatively, the fibers of the present invention are characterized as fibers having a relatively high degree of monoaxial polymer orientation. In this context, the orientation is reference to the alignment of the polymer chains, thereby imparting enhanced tensile strength, or modulus values, as noted above. As noted, the monoaxial orientation of the fibers herein is at least 50% or higher, more preferable 75%, and in a most preferred embodiment the monoaxial orientation is at or greater than 90%. In addition, those skilled in the art will appreciate that the invention herein contemplates the use of polymer resins that contain, naturally, such high levels of polymer orientation, as well as through polymer resins in which the orientation may be developed through a controlled stretching type process, and in particular, stretching between values of Tg an Tm, followed by cooling. However, cold stretching below Tg is contemplated herein.

In that regard, while the invention herein discloses oriented fiber materials, it can be appreciated that the invention herein can apply to oriented film material, and in that context, either monoaxial or biaxial film material as a material for use with the compressible material that is employed to form the soft chew toy. Such film material would therefore preferably include those film materials that have a tensile strength equal to or over 20,000 psi in the direction of orientation, preferably over 30,000 psi, which is alternatively referred to as the “machine direction” or “MD”. In addition, the invention herein contemplates the use of biaxial oriented film wherein the orientation of the polymer chains in the direction transverse to the machine direction, or “TD” is also equal to or over a value of 20,000 psi, and preferably 30,000 psi. In modulus values, the preferred value for the modulus in the machine direction at equal to or over a value of 500,000 psi, and preferably over 700,000 psi. In the transverse direction the preferred modulus value are equal to or greater than 500,000 psi, and preferably over 700,000 psi. Accordingly, such biaxially orientated films provide excellent resistance to puncture and tearing.

In addition, the term “fiber” as used herein refers to an elongated, individual unit of matter, either natural or synthetic, that forms the basic element of fabric. Fibers therefore may comprise filamentary structures of very small cross-sections typically 0.10 to 0.13 mm (0.004 to 0.005 in) made from various materials. The fiber may have a length that is typically 100 times their diameter. Fibers can be continuous or made up of short or staple fiber lengths. The term “fabric” as used herein may included any woven, felted, bonded or knotted textile material, and it is understood that there are both woven and nonwoven fabrics that are included herein. The term “film” herein refers to materials that typically have a thickness of up to about 0.050 inches, and can be the result of extrusion of calendaring operations, as well as solvent casting, chemical conversion, and skiving from solid rolls. In addition, those of ordinary skill in the art will recognize that the term “film” herein may include what is otherwise described as sheet material, which includes plastic material whose thickness is relatively small or reduced in dimension in proportion to its length and width.

By way of specific example, an animal chew consistent with the present invention may include a layer of fabric including aramid fiber, such as Kevlar® from DuPont Chemical Co. Aramid fiber generally exhibits a tensile strength in the range of between about 475,000 psi to 650,000 psi. The modulus of aramid fiber is generally in the range of about 12 Mpsi to 27 Mpsi. An animal toy including a fabric layer incorporating aramid fiber with these performance characteristics will provide improved resistance to tearing or rupture. Furthermore, while no numerical value is indicated herein, aramid fiber is also characterized by generally high resistance to abrasion.

In connection with the above, by the term “aramid” it is meant to include a polyamide wherein at least 85% of the amide linkages (—CO—NH—) are attached directly to two aromatic rings. Suitable aramid fibers are described in U.S. Pat. Nos. 4,172,938; 3,869,429; 3,819,587; 3,673,143; 3,354,127 and 3,094,511.

In another example, an animal toy consistent with the present invention may include a fabric layer including highly linear and oriented polyethylene, such as that sold under the trade name Spectra™ by Honeywell International Inc. Linear polyethylene generally has a tensile strength that is in the range of between about 300,000 psi to 475,000 psi. Linear polyethylene may exhibit a modulus that is in the range of between about 9 Mpsi to 16 Mpsi.

Those having skill in the art will recognize that other similarly high strength fibers may suitable for producing animal toys consistent with the present invention. In addition to aramid fiber and linear polyethylene fiber, discussed above, exemplary alternative materials may, for example, include spun liquid crystal polymer, available as Vectran™ from Celanese AG; and poly(p-phenylene-2,6-benzobisoxazole) fiber, such as Zylon™ fiber available from Toyobo Co., Ltd. Numerous other fibers consistent with the invention herein will be apparent to those having skill in the art.

According to one aspect of the present invention, the animal toy may be a stuffed toy. The stuffed toy may include a resilient or compressible material covered by an exterior layer of high performance fabric. The resilient or compressible material may include conventional stuffing materials, such as foamed polymeric material, fiber based batting or fill, elastomeric material, shredded material, etc. Those having skill in the art will readily appreciate that various additional materials having a relatively high bulk density may also be used as stuffing.

An animal toy consistent with the present invention is not restricted to any particular shape or configuration. For example, the animal toy may include a stuffed dog bone. The outer layer of the stuffed dog bone may be formed from woven aramid cloth. The stuffing may be a conventional, natural or synthetic batting or fill, such as polyester, nylon, cotton or wool. The stuffing or compressible material may exist throughout the toy, or be isolated to certain regions. Accordingly, while the animal toy may have a soft feel in the mouth of a pet, the preferred aramid cloth outer layer will resist rupture from biting, and will resist tearing or ripping from vigorous tugging. Alternative shapes may include that of a stuffed ring, ball, other animal, etc.

As a further alternative, the animal toy herein may be a folded, rolled, twisted, etc. structure, rather than a stuffed toy. For example, an animal chew may be formed from high performance fabric rolled to form a cylindrical member. The shape of the animal toy may be maintained by tying the ends of the cylindrical member, or stitching the higher performance fabric so that it retains the shape. Of course, numerous other configurations are also possible within the spirit of the present invention.

As alluded to previously, the animal toy herein need not be constructed entirely of high performance fabric. For example, the animal chew may include a first layer of fabric including high strength fibers, as previously disclosed herein. At least of portion of the animal chew may include a second, outer layer that is not a high performance fabric. In that sense, such non-high performance fibers are those fibers that have mechanical properties less than those for the high performance fabric recited herein. This would include, but note be limited to aliphatic nylons, certain polyesters (e.g., PET), cellulosic materials (cotton), etc. The second layer may overlie at least a portion of the first layer, and may be used to provide specific visual or tactile characteristics. For example, the second layer may include a plush material or simulated hair or fur. The second layer may simply be disposed over the first layer. Alternatively, the second layer may be stitched or bonded to the first layer. Accordingly, while the second layer may not include high strength fibers, the animal toy may still have improved resistance to biting, scratching, or tearing resulting from the first layer of high performance fabric.

According to another aspect, the overall durability of the animal toy may be further improved by providing the animal chew having multiple layers of high performance fabric. That is, a second layer of high performance fabric may be provided disposed at least partially overlying a first layer of high performance fabric. A multi-layer construction may further improve the durability of the animal toy, especially with regards to puncture/rupture resistance. Additionally, by using a multi-layer construction the mechanical properties of the animal toy may be improved without imparting the stiffness of a single heavy layer of fabric material.

According to a related aspect, the high performance fabric may include an axis of orientation, i.e., the fabric may have a higher strength in one direction versus another direction. The animal toy may include multiple layers of high performance fabric wherein an axis of orientation of a layer of high performance fabric is not aligned with an axis of orientation of an adjacent layer of higher performance fabric, i.e., the axes of orientation of adjacent layers are at an angle relative to one another, and such angle may vary between 1-179 degrees, including all 1.0 degree increments therebetween. In the most extreme case of this aspect, the axes of orientation of adjacent layers may be arranged perpendicular (i.e., at 90 degrees) to one another. However, such a perpendicular configuration is not essential, but only preferred.

In connection with the above, it should be appreciated that the preferred fibers of the present invention, or film material, include those fibers or films that indicate a monoaxial orientation of levels above at least 50%. More preferably, the degree of monoaxial orientation is between about 50-100%, including all 1.0% increments therebetween, and all ranges therebetween. For example, the monoaxial orientation of the fibers of film may lie between 70-90%, or 80-95%, or 90-95%, etc.

The present invention has been set forth in reference to various exemplary preferred embodiments, but it should be understood by those skilled in the art that such exemplary embodiments are by way of illustration only. Modifications and variation will therefore be apparent and may be sorted to without departing from the spirit and equivalent scope of this invention. Accordingly, such modifications and equivalents should be considered to be within the purview of the scope of the invention as set forth in the appended claims.

1. An animal toy comprising a body portion, said body comprising a compressible material and a first fabric material disposed at least partially over said compressible material, said first fabric material comprising fibers having a tensile strength greater than or equal to 50,000 psi and/or a modulus greater than or equal to 500,000 psi.

2. The animal toy according to claim 1, wherein the tensile strength of said fibers is greater than or equal to 100,000 psi.

3. The animal toy according to claim 1, wherein said tensile strength of said fibers is greater than or equal to 200,000 psi.

4. The animal toy according to claim 1, wherein said modulus of said fibers is at least 1 Mpsi.

5. The animal toy according to claim 1, wherein said modulus of said fibers is between about 1 Mpsi and 30 Mpsi.

6. The animal toy according to claim 1 further comprising a second fabric material disposed over at least a portion of said first fabric material.

7. The animal toy according to claim 6, wherein said second fabric material comprises fibers having a tensile strength greater than or equal to 50,000 psi and/or a modulus greater than or equal to 500,000 psi.

8. The animal toy according to claim 7, wherein the first fabric material comprises fibers that have a first axis of orientation, and wherein said second fabric material comprise fibers having a second axis of orientation, and wherein said first and second axis of orientation are different.

9. The animal toy according to claim 8 wherein said first and second axis of orientation intersect one another to form an angle of between 1-179 degrees.

10. The animal toy according to claim 1, wherein said fabric material comprises aramid fiber.

11. The animal toy according to claim 1, wherein said fabric material comprises polyethylene fiber.

12. The animal toy according to claim 1, wherein said compressible material comprises a foam material.

13. The animal toy according to claim 1, wherein said compressible material comprises at least one of natural and synthetic batting or fill.

14. The animal toy of claim 13 wherein said batting or fill is selected from the group consisting of polyester, nylon, cotton, wool, or mixtures thereof.

15. The animal toy of claim 1, wherein said first fabric material is disposed completely over said compressible material.

16. The animal toy of claim 1, wherein said fibers of said fabric material have a monoaxial orientation of greater than about 50%.

17. An animal toy comprising a body portion, said body comprising a compressible material and a film material disposed at least partially over said compressible material, said first film material comprising fibers having a tensile strength greater than or equal to 20,000 psi and/or a modulus greater than or equal to 500,000 psi.

18. The animal toy of claim 17, wherein said film material is disposed completely over said compressible material.
